(19) United States
(12) Patent Application Publication
(10) Pub. No.: US 2017/0344935 A1
(43) Pub. Date: Nov. 30, 2017

(54) SYSTEMS AND METHODS FOR ARRANGING SENSORS TO MONITOR MERCHANDISE CONDITIONS AT OR NEAR SHELVES

(71) Applicant: Wal-Mart Stores, Inc., Bentonville, AR (US)

(72) Inventors: Todd D. Mattingly, Bentonville, AR (US); David C. Winkle, Bella Vista, AR (US); Bruce W. Wilkinson, Rogers, AR (US)

(21) Appl. No.: 15/602,220

(22) Filed: May 23, 2017

Related U.S. Application Data
(60) Provisional application No. 62/342,540, filed on May 27, 2016.
(60) Provisional application No. 62/342,529, filed on May 27, 2016.

(51) Int. Cl. G06Q 10/08; G06K 7/10

(52) U.S. Cl. CPC G06Q 10/087; G06K 7/10366

(57) ABSTRACT

In some embodiments, apparatuses and methods are provided herein useful to monitoring the conditions of merchandise on shelves at a shopping facility. In some embodiments, there is provided a system for monitoring merchandise on shelves including: a shelf comprising a bottom surface and side surfaces and configured to support merchandise; a first array of sensors arranged on the bottom surface of the shelf and configured to measure at least one of weight, pressure, temperature, and moisture; a second array of sensors arranged on one or more side surfaces of the shelf and configured to measure at least one of weight, pressure, temperature, and moisture; and at least one interface operatively coupled to the first and second arrays of sensors, the at least one interface configured to transmit sensor data from the first and second arrays to a central computing system.

### CROSS-REFERENCE TO RELATED APPLICATION

This application claims the benefit of U.S. Provisional Application No. 62/342,540, filed May 27, 2016, and U.S. Provisional Application No. 62/342,529, filed May 27, 2016, which are incorporated herein by reference in their entirety.

### TECHNICAL FIELD

This invention relates generally to monitoring merchandise at shelves, and more particularly, to monitoring the conditions of merchandise on or near the shelves at a shopping facility.

### BACKGROUND

In the retail setting, one important aspect involves the conditions of merchandise on the shelves at a shopping facility. Retailers are continually monitoring these conditions in order to make sure that the merchandise is presented in a desirable manner to customers. For example, if the merchandise includes perishable items, retailers will monitor the perishable items closely to observe the remaining shelf life, to adjust pricing, and to remove the perishable items when they are no longer desirable for sale.

Accordingly, there is a need to provide an arrangement of several arrays of sensors on or about merchandise shelves in order to closely monitor the merchandise. It would be desirable to gather different types of data points from these various types of sensors in order to evaluate various characteristics of the merchandise. There is a need for sensory data and data points that allow retailers to make immediate, short-term decisions regarding the merchandise. However, it would also be desirable to allow a retailer to determine long term data trends from these data points, such as analyzing merchandise freshness levels, traffic patterns near the merchandise, stocking patterns of the merchandise, and merchandise temperature compliance.

### BRIEF DESCRIPTION OF THE DRAWINGS

Disclosed herein are embodiments of systems, apparatuses and methods pertaining to monitoring the conditions of merchandise on or near the shelves at a shopping facility. This description includes drawings, wherein:

FIG. 1 is a schematic representation in accordance with some embodiments;

FIG. 2 is a schematic representation in accordance with several embodiments;

FIG. 3 is a block diagram in accordance with some embodiments;

FIG. 4 is a flow diagram in accordance with several embodiments;

FIG. 5 is a block diagram in accordance with some embodiments; and

FIG. 6 is a flow diagram in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to monitoring the conditions of merchandise on or near the shelves. In some embodiments, there is provided a system for monitoring merchandise on shelves including: a shelf comprising a bottom surface and side surfaces and configured to support merchandise; a first array of sensors arranged on the bottom surface of the shelf and configured to measure at least one of weight, pressure, temperature, and moisture; a second array of sensors arranged on one or more side surfaces of the shelf and configured to measure at least one of weight, pressure, temperature, and moisture; and at least one interface operatively coupled to the first and second arrays of sensors, the at least one interface configured to transmit sensor data from the first and second arrays to a central computing system.

In one form, the first array of sensors may include a plurality of individual strips defining a grid extending along the bottom surface of the shelf. Further, the first array of sensors may be formed of piezoelectric material and may be configured to measure weight, pressure, temperature, and moisture at predetermined locations along the bottom surface of the shelf. In addition, the second array of sensors may be disposed at predetermined vertical positions along at least one side surface of the shelf. Also, the second array of sensors may include a plurality of individual strips defining a grid extending along the at least one side surface of the shelf. Moreover, the first array or second array of sensors may include at least one gas emission sensor.

In one form, in the system, the at least one interface may include an RFID device with a memory having a predetermined number of bits equaling the number of sensors in the first array of sensors; and each bit may correspond to a sensor in the first array of sensors. Further, the system may include a third array of sensors disposed at predetermined vertical positions. In addition, the third array of sensors may be disposed at a top surface of the shelf. Also, the third array of sensors may include one or more optical sensors. Moreover, in the third array, the one or more optical sensors may include one or more CCD cameras configured to identify the type or orientation of merchandise based on at least one of barcode labels, RFID tags, text recognition, or color recognition.

In another form, there is provided a method for monitoring merchandise on shelves including: providing a shelf comprising a bottom surface and side surfaces and configured to support merchandise; by a first array of sensors, measuring at least one of weight, pressure, temperature, or moisture at predetermined locations along the bottom surface of the shelf; by a second array of sensors, measuring at least one of weight, pressure, temperature, or moisture at predetermined locations along at least one side surface of the shelf; and by an interface, transmitting sensor data from the first and second arrays to a central computing system.

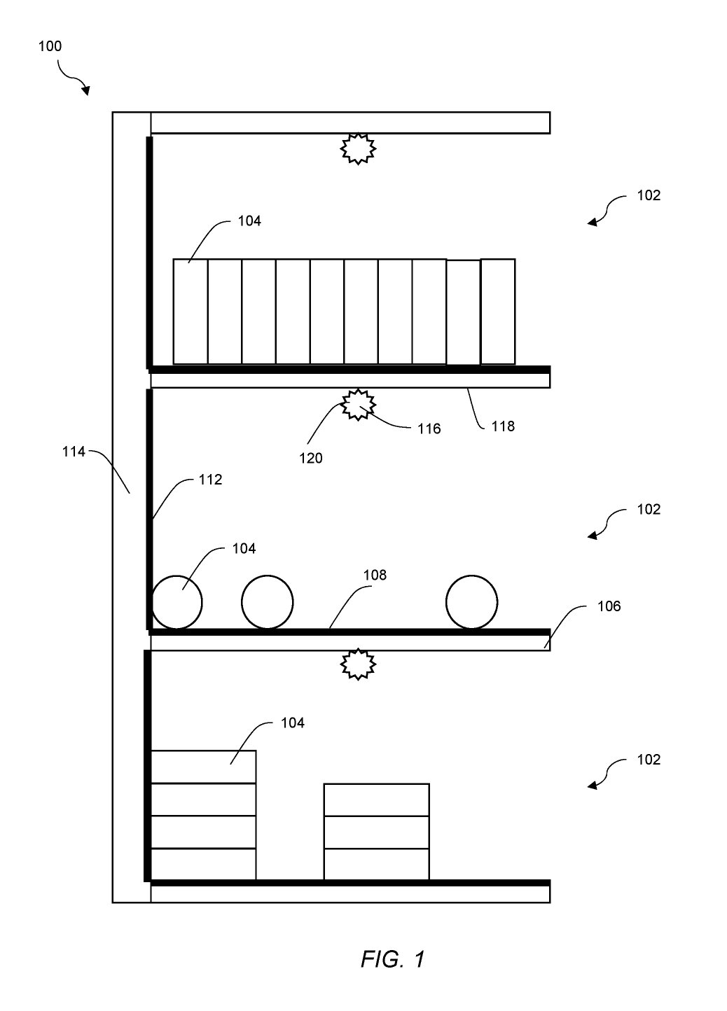

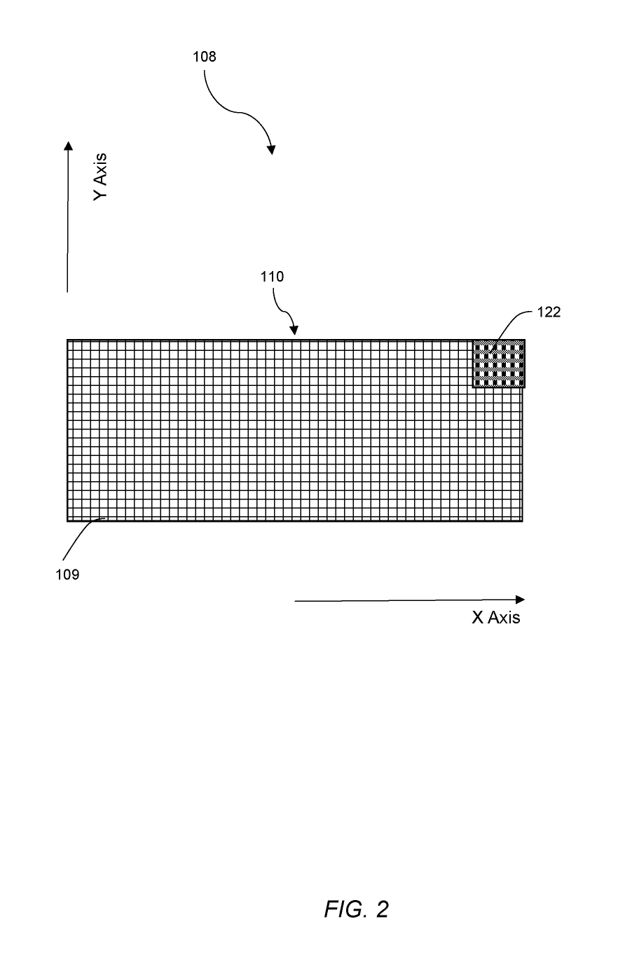

As shown in FIGS. 1 and 2, there is provided a system 100 for an arrangement of sensors at or near a shelf. It is generally contemplated that there are, at least, two sensor arrays (and possibly three arrays) for measuring conditions at the shelf. In one form, it is contemplated that it may be desirable to use these multiple arrays of sensors for high value (or especially perishable) merchandise. Also, these data can be used both to address short term, immediate concerns and to identify and predict long term trends in the merchandise.

In FIG. 1, there are shown three shelves 102 supporting various types of merchandise 104. For each shelf 102, the bottom surface 106 includes a first array of sensors 108. In one form, it is generally contemplated that this first array 108 is selected to measure weight, pressure, temperature, and/or moisture. More particularly, in one form it is contemplated that the first array of sensors 108 includes pressure-sensitive sensors that detect the weight of the merchandise 104 on the shelf 102 being supported by the bottom surface 106.

As can be seen from FIG. 2, the first array of sensors 108 may be arranged as multiple individual sensor strips (generally square in shape) 109 extending along the bottom surface 106 and defining a sensing grid or matrix 110. In some forms, it is contemplated that the sensors 109 may be built into the shelf 102 itself or may be incorporated into a liner or mat supported by the bottom surface 106. Although the first array of sensors 108 is shown as arranged to form a grid 110, it should be evident that many other arrangements are possible. For example, the first array of sensors 108 may also be in the form of lengthy rectangular sensor strips extending along either the x-axis or y-axis in FIG. 2. It is generally desirable to select the first array of sensors 108 such that the data regarding the merchandise 104 over the entire bottom surface 106 can be detected, such as, for example, detecting pressure or weight indicating the presence or absence of merchandise at each individual sensor 109. In one form, the bottom surface 106 is covered with an appropriate first array of sensors 108 with sufficient discrimination and resolution so that, in combination, the sensors 109 are able to identify the quantity (and possibly the type) of merchandise 104 on the shelf 102.

In one form, the first array of sensors 108 may be formed of piezoelectric material. It is generally contemplated this material may be suitable because piezoelectric sensors are versatile sensors that can measure various characteristics, including pressure, force, and temperature. Also, piezoelectric sensors are fairly sturdy and therefore do not need to be replaced frequently. As should be evident, although piezoelectric sensors are one suitable sensor type, it should be evident that many other sensor types may also be used, such as, for example, other types of pressure/weight sensors (load cells, strain gauges, etc.).

The system 100 also includes a second array 112 with sensors configured to measure at least one of weight, pressure, temperature, and moisture. As can be seen from FIG. 1, the second array 112 is arranged on a side (or vertical) surface 114 of the shelf. In this context, it should be understood that the term “side” surface refers to any of the vertical surfaces 114 of the shelf 102, including a front surface, a rear surface, and left and right lateral surfaces. Further, although FIG. 1 shows the second array of sensors 112 disposed on the side (rear) surface 114, it should be understood that the second array of sensors 112 may be disposed on more than one side (or vertical) surface 114. It may be desirable to mount the second array of sensors 112 on more than one side surface 114 so as to generate more data points or sensory data to better monitor certain conditions at the shelf. For some high value merchandise, it is contemplated that some or all of the surfaces of the shelf 102 may include sensor arrays so as to define a number of “smart” surfaces.

In one form, the second array of sensors 112 may be arranged in a similar manner along one or more side surfaces 114 as the first array of sensors 108 is arranged along the bottom surface 106. For example, the second array of sensors 112 may be arranged as multiple individual sensor strips that collectively define a grid. Further, this second array of sensors 112 may also be formed of piezoelectric material.

Alternatively, the second array of sensors 112 may be temperature sensors that are positioned at different heights along one or more side surfaces 114. Under this approach, the first array of sensors 108 may be directed to collecting weight data at the bottom surface 106 of the shelf 102, while the second array of sensors 112 is directed to collecting temperature data. It is generally contemplated that the type of sensor in the first and second arrays 108, 112 may be selected so that each array collects a certain type of data that complements the data collected by the other array.

As another alternative, the second array of sensors 112 may include gas emission sensors. These types of sensors are useful in detecting chemicals that may be associated with the deteriorating condition of certain perishable items, such as, for example, certain types of fruit. As should be evident, gas emission sensors may also be incorporated into the first array of sensors 108.

In another form, the second array of sensors 112 may include different types of sensors that are positioned at different positions along the side surface(s) 114. It is generally contemplated that the second array of sensors 112 may be some desired combination of weight, pressure, temperature, and/or moisture sensors in order to collect different types of data. For example, the second array of sensors 112 may include some combination of weight and/or pressure sensors that may determine how “crowded” the shelf 102 is with merchandise, temperature sensors that may determine temperature at different locations of the shelf, and/or moisture sensors that may determine if any of the liquid-containing merchandise may have spilled. As should be understood, a desired combination of different sensor types may also be arranged in the first array of sensors 108 disposed along the bottom surface 106 of the shelf 102. As an example, a grid-like arrangement of sensors 109 may be used (as shown in FIG. 2) in which sensor types are alternated in the grid in some manner so as to collect different types of data.

Optionally, the system 100 may also include a third array 116 with sensors that are disposed at certain vertical position(s) on or about the shelf 102. In FIG. 1, the third array of sensors 116 is shown as disposed at a top surface 118 of the shelf 102. More specifically, in this example, the third array of sensors 116 includes one sensor 120 that is mounted directly above the shelf 102. It should be understood that the third array of sensors 116 may include several individual sensors and may be mounted at different heights on or about the shelf 102.

In one form, it is contemplated that the third array of sensors 116 may include one or more optical cameras (although other sensor types may also be used). Further, in one preferred form, the third array of sensors 116 may include charged-coupled devices, also referred to as CCD camera(s). These digital imaging devices may be selected to be relatively small in size and provide relatively high-quality image data. Alternatively, it is also contemplated that active-pixel sensors (APS) may be used (which include CMOS APS sensors). These sensors generally provide lower quality image data but may be less expensive than CCD sensors and use less power. The optical cameras are positioned at or about the shelf 102 to be able to view the merchandise 104 on the shelf 102. In one form, eight optical cameras could be positioned in each corner of the shelf 102.

In one form, this third array of sensors 116 are configured to identify the type or orientation of merchandise, and this identification may be done in several different ways. For example, regarding type, the third array of sensors 116 may be configured to capture images and thereby read barcode labels, recognize text, or recognize color of the merchandise, and/or the third array of sensors 116 may detect RFID tags. In one form, these image data may be compared to merchandise images in an image database to identify the merchandise 104 and make sure that all of the merchandise items on the particular shelf 102 are the correct ones. As another example, regarding orientation, the third array of sensors 116 may be configured to capture images that show if the merchandise 104 is front facing (as may be desirable), offset with respect to front facing, or may be knocked over and lying on its side.

The types of sensors used in the first, second, and optional third arrays 108, 112, 116 may be selected and customized to the particular nature of the merchandise 104 on the shelf 102. In one form, the sensors may be determined or selected based on the perishable nature of the product. For example, potatoes are not particularly sensitive to temperature, so the arrays of sensors may omit temperature sensors. In contrast, there may be temperature sensors inside freezer units, refrigerated units, and room temperature areas, such as for products like ice cream and milk. In another example, an array may include gas sensors to monitor apples, bananas, and grapes on the shelf 102. Alternatively, the first, second, and third arrays may be standardized to include various types of sensors, and the sensor data that is relevant to the particular merchandise may be considered and analyzed, while sensor data that is not relevant may be ignored.

The system 100 also includes at least one interface 122 for transmitting the sensory data to a central computing system. The interface(s) 122 may be in wired or wireless communication with the central computing system. In one form, each of the arrays may be coupled to an interface for transmission of the data. In other words, the first array of sensors 108 may be coupled to a first interface, the second array of sensors 112 may be coupled to a second interface, and the optional third array of sensors 116 may be coupled to a third interface. As should be evident, in another form, the various arrays may be collectively combined to an interface for transmission of the sensory data to the central computing system.

In one form, it is contemplated that the interface 122 may be a radio frequency identification (RFID) device with a memory having a predetermined number of bits equaling the number of sensors in the first array of sensors 108 where each bit corresponds to a sensor 109 in the first array of sensors 108. So, for example, the first array of sensors 108 may be a 16×16 grid that defines a total of 256 individual sensors 109, and this first array of sensors 108 may be coupled to a 256 bit RFID device such that each individual sensor 109 corresponds to an individual bit. In addition, the second array of sensors 108 may be arranged in a similar manner. In other words, they may collectively define a 16×16 grid that is coupled to a 256-bit RFID device. As should be evident, these are just examples, and other array arrangements are possible where there is a 1:1 correspondence between individual sensors and bits of an RFID or memory device.

In one form, the RFID device including a 256 bit memory may be configured to store the location information of the shelf 102 in the shopping facility and location information of merchandise items on the shelf 102. Based on detected changes in pressure, weight, and/or temperature, the sensor 109 may configure the corresponding bit of the memory located in the RFID device (as a logic “1” or a logic “0”). The RFID device may then transmit the location of the shelf 102 and data corresponding to changes in the memory to the central computing system.

In one form, it is generally contemplated that a user may be able to utilize the sensor data to address short term, immediate needs at the shopping facility. For example, the central computing system may be configured to analyze the sensor data and determine such conditions as low inventory on the shelf, liquid spills on the shelf, measured temperatures exceeding a temperature threshold and a desired temperature range, and improper/misplaced/wrongly facing merchandise on the shelf. The central computing system may then flag the issue and send out an alert to an employee of the shopping facility and/or create a task that needs to be addressed immediately. These issues may then be corrected, such as by stocking the shelf with more inventory, cleaning up the liquid spill, adjusting or repairing the temperature settings at the shelf, replacing incorrect products with the correct merchandise on the shelf, or re-orienting merchandise so that it is once again forward facing.

The information may be used in other ways to address immediate needs. For example, the sensor arrays in the shelf 102 would help confirm the identity of merchandise 104 based on the detected physical characteristics of the merchandise 104 on the shelf 102. Further, as other examples, the sensor arrays can also potentially identify damaged merchandise 104 on the shelf 102 (such as merchandise containers broken open) or that the temperature differential is incorrect (condensation may drip onto the first array of sensors in the mat or bottom surface 106). So, this information could be used to provide real time notice back to employees or to the inventory management system or other systems.

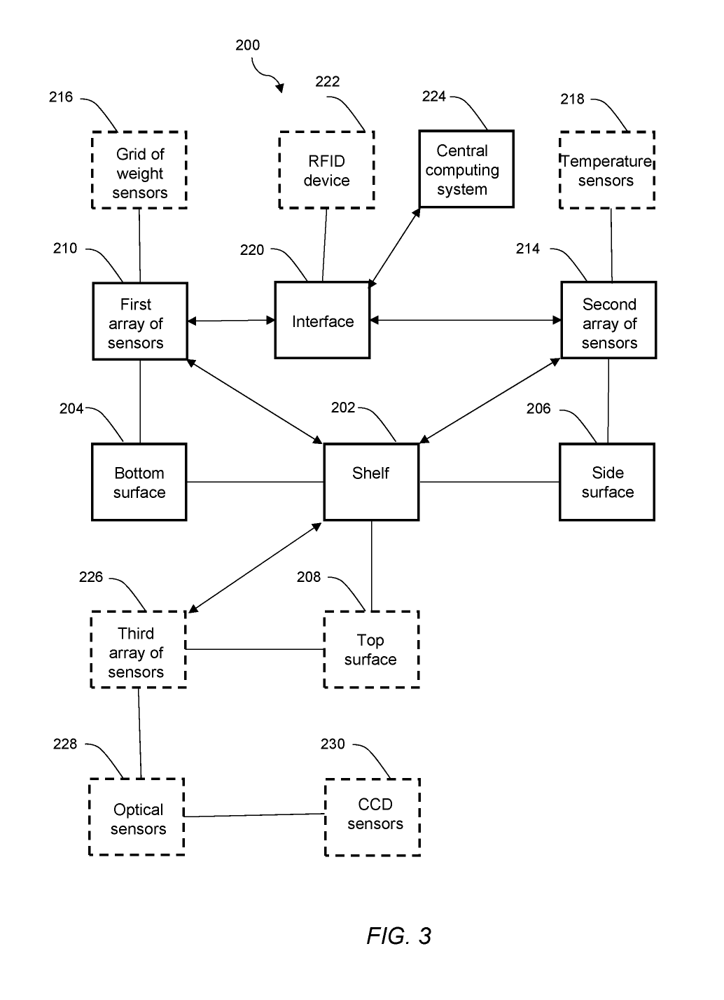

In FIG. 3, there is shown a block diagram illustrating various components of a system 200 that may make use of the components described above. As can be seen, in one form, the system 200 includes a shelf 202 supporting merchandise that includes a bottom surface 204, at least one side surface 206, and optionally a top surface 208. A first array of sensors 210 is disposed along the bottom surface 204, and a second array of sensors 214 is disposed at various positions along the side (or vertical) surface 206. In one form, the first array of sensors 210 may be arranged as a sensory grid 216 of individual weight or pressures sensors, and the second array of sensors 214 may be arranged as temperature sensors 218 disposed at selected points along the side surface 206. Further, in this form, the first and second arrays 210, 214 may be coupled to an interface 220 (which may be an RFID device 222). In other forms, the first and second arrays 210, 214 may be coupled to separate interfaces. In turn, the interface 220 is in communication with and transmits sensory data to a central computing system 224. In one form, a third array of sensors 226 may be arranged at or near the top surface 208. The third array 226 may be in the form of one or more optical sensors 228 (such as CCD sensor(s) 230) that capture image data, which may be used to identify the type or orientation of merchandise on the shelf 202. This image data may be transmitted to the central computing system 224 for processing and analysis.

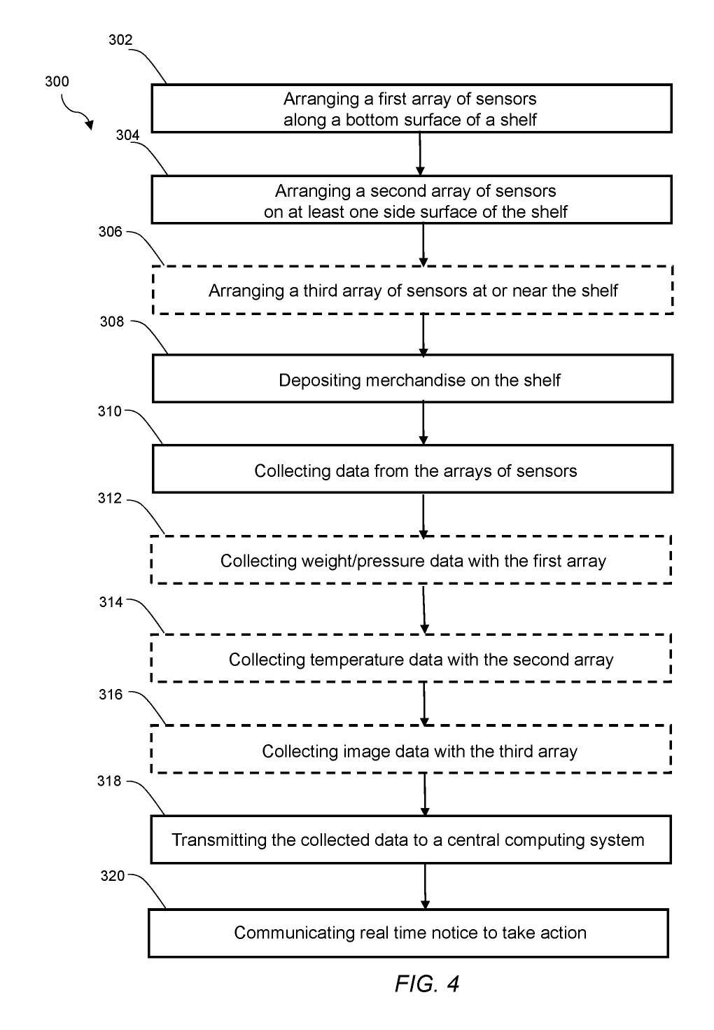

In FIG. 4, there is shown a flow diagram showing various steps of an illustrative process 300 that may make use of the components described above. At blocks 302-08, the various arrays of sensors are disposed at or near the shelf, and the merchandise is deposited on shelf. At block 302, a first array of sensors are arranged along the bottom surface of the shelf, and at block 304, a second array of sensors are arranged along the side surface(s) of the shelf. Optionally, at block 306, a third array of sensors is arranged at or near the shelf. At block 310, data is collected from the various sensor arrays. Blocks 312-16 show one possible type of arrangement of the sensor arrays. At block 312, the first array collects weight/pressure data, at block 314, the second array collects temperature data, and at block 316, the third array collects image data. As should be evident, this example is just one type of arrangement, and other arrangements are possible. At block 318, sensor data from the arrays is transmitted to a central computing system, and block 320, the central computing system transmits a real time notice to take some action in response to the analysis of the sensor data.

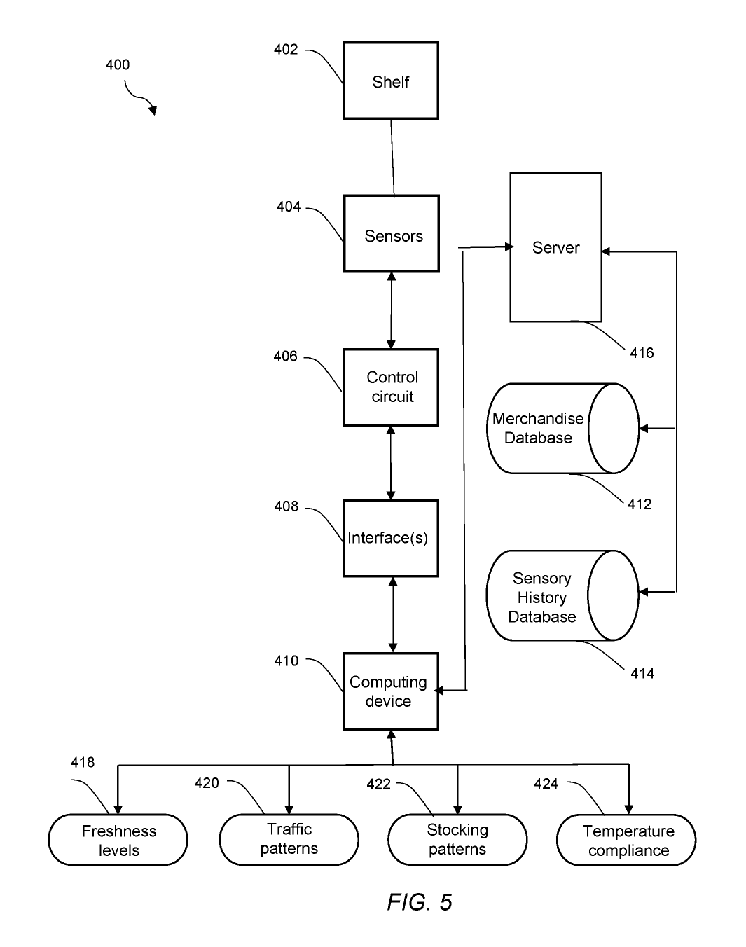

Sensory data may also be processed and analyzed over time to determine, identify, predict, and extrapolate long term data trends and analytics. In FIG. 5, there is shown a block diagram illustrating various components of a system 400 that may make use of the components described above to determine data trends over time. These data trends may be analyzed in the context of a specific shopping facility to address and improve conditions at the shopping facility. The data may also be used more broadly to identify potential long term trends among a number of shopping facilities. In one form, it is contemplated that the sensory data may be utilized in the context of four general categories: merchandise freshness levels, traffic patterns near merchandise, stocking patterns of the merchandise, and merchandise temperature compliance.

In FIG. 5, there is shown a shelf 402 with sensors 404 arranged on or about the shelf 402 that are monitoring conditions of the merchandise. In one form, it is contemplated that the sensors 404 may be arranged in the first, second, and (optionally) third arrays with the various types of sensors addressed above. However, it is also contemplated that there may be other arrangements of sensors that may be utilized to collect sensor data that may be analyzed for data trends addressed further below.

The system 400 also includes a control circuit 406 that is configured to take periodic measurements and/or collect data at certain time intervals. This control circuit 406 may also be used in the systems 100 and 200 described above. In this context, the term control circuit 406 refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 406 may be configured (for example, by using corresponding programming stored in a memory as will be well understood by those skilled in the art) to carry out one or more of the steps, actions, and/or functions described herein.

The control circuit 406 collects sensory data at certain time intervals. The time intervals may be selected so as to be different for different types of sensors that are present in the arrangement of sensors. For example, the control circuit may collect weight data of the merchandise on the shelf 402 every hour, may collect temperature data every half hour, and/or may collect continuous video or still images taken every five minutes in one arrangement of sensors. In addition, the control circuit 406 may take measurements and/or collect data at different types of merchandise. For example, the control circuit may take more frequent measurements of certain sensors for perishable items, while collecting data less frequently and collecting different types of data for non-perishable (or less perishable) items.

The system 400 may include one or more interfaces 408 that transmit sensory data to a computing device 410 that may identify and predict data trends. In one form, it is contemplated that there may be a central interface that transmits all of the data from all of the sensors. Although the central interface may be a discrete device separate from the control circuit 406, it is also contemplated that the interface 408 may be part of and integrated with the control circuit 406. In some forms, the interface(s) may be a data reading/transmitting device, an RFID device, a near field communication (NFC) device, a Bluetooth low energy device, an imaging communication interface, and the like.

Further, as described earlier, it is contemplated that there may be several interfaces 408 in which each interface may be associated with a separate array (or grouping) of sensors. For example, in one form, one of the interfaces 408 may be an RFID device with a memory having a predetermined number of bits equaling the number of sensors in a first array of sensors (such as weight sensors alone or in combination with other sensors) where each bit corresponds to a sensor in the first array; a second interface may be an RFID device or other interface in communication with weight, temperature, and/or other sensors; and a third interface may communicate imaging data from an imaging device. The interfaces 408 may communicate this data in a wired or wireless manner.

The system 400 includes a computing device (or analytics engine) 410 that analyzes the sensor data. It is contemplated that the computing device 412 may access one or more databases to determine data trends regarding the merchandise. In one form, the computing device 410 may access a merchandise database 412 regarding specific characteristics and data for the particular merchandise items being monitored. The computing device may also access a sensor history database 414 (or memory device) that may store and record the sensor readings for various types of merchandise being monitored. The computing system 410 and databases may be located and communicate with one another in any of various ways. Generally, the computing device/analytics engine 410 may be any network accessible processor based device such as a remote, web-based, and/or cloud based server. In one example, computing device 410 may be located in conjunction with the database(s) at the shopping facility or may be located more remotely, such as at a cloud computing system. Also, the computing device 410 may access the database(s) via an input/output hub that communicates wirelessly with the shopping facility server 416 or with the cloud computing system. In some embodiments, the functions of the analytics engine 410 may be implemented by multiple physical devices. It is contemplated that the computing device (or analytics engine) 410 may analyze any of various data trends.

First, the computing device 410 may evaluate merchandise freshness levels 418, particularly for perishable merchandise. When the computing device/analytics engine 410 receives sensor data, it may combine it with the sensor reading history and with specific information regarding the merchandise from the merchandise database 412. For example, the merchandise information may include data about the merchandise, such as shelf life, to be evaluated in conjunction with sensor readings allow the calculation of a sell-by date, an estimated expiration date, and/or a stage of ripeness. In some forms, the determination of freshness level may include a task to be performed by a sales associate such as: place the perishable product on a sales floor, relocate the perishable product, remove the perishable product from sales, move the perishable product into climate controlled storage, apply a discount to the perishable product, and the like. In some forms, the information associated with freshness level may include a recommendation to a consumer, such as: a best-by date, available discounts, a suggested use of the perishable product based on the perishable product's current freshness, and the like. In some forms, the computing device/analytics engine 410 may determine information regarding the ripeness or freshness left on an item based on predictive comparisons of other similar items. In some forms, the computing device 410 may use any known methods to determine the estimated expiration date and/or stage of freshness.

In one form, the sensors 404 are arranged to detect color or texture changes in the merchandise. For example, the arrangement of sensors may include optical sensors (such as in a third array of sensors) that capture image data of the merchandise. It is known that the color and/or texture of certain perishable items, including, for example, certain meat and fruit (such as pears and apples), will change over time. However, non-perishable items may also exhibit color changes over time, such as due to fading over time when exposed to sunlight. The optical sensors can take continuous video or still images at certain time intervals, which show the color or texture of the merchandise over time and the changes in color or texture. These image data can be compared to preexisting image data from the merchandise database 412 for that particular merchandise that may be associated with preexisting remaining shelf life predictions for the merchandise. Thus, the computing device 410 may be configured to analyze merchandise freshness levels based on the analysis of sensor data over a predetermined amount of time for color or texture changes of the merchandise to determine shelf life. Further, the computing device 410 may be configured to adjust the pricing of the merchandise based on the determination of shelf life.

In another example, the arrangement of sensors may include gas emission sensors (such as in a second array of sensors) that detect gas emissions of chemicals from the merchandise indicating a change in freshness. It is known that certain fruit and other perishable items will emit chemicals indicating ever-decreasing shelf life. The gas emission data can be compared to preexisting data from the merchandise database 412 for that particular merchandise that may be associated with preexisting shelf life predictions for that merchandise. So, the computing device 410 is configured to analyze merchandise freshness levels based on the analysis of the gas emission data over a predetermined amount of time for chemical changes in the merchandise to determine shelf life. Pricing may be adjusted accordingly.

It is also contemplated that the sensor readings in the sensory history database 414 may be used to modify the preexisting shelf life predictions in the merchandise database 412. For example, an evaluation of the sensor readings may show that certain color, texture, and/or gas emission data empirically resulted in either a shorter or longer shelf life for the merchandise than was predicted by preexisting standards. Accordingly, the sensory history database 414 can be iteratively evaluated to correct and update shelf life predictions for various types of merchandise. It is also contemplated that the evaluation of freshness levels indicated above may be performed manually by an individual (instead of via computing device 410) or based on some combination of manual and computing activity.

Second, the computing device 410 may evaluate traffic patterns 420 near the merchandise to gauge customer interest rates, customer purchase rates, and merchandise tampering. For example, the sensors 404 may be arranged to detect the movement of people at or near the shelf and the handling of the merchandise by people. In one form, the arrangement of sensors may include optical sensors (such as in a third array of sensors) that capture image data at or near the merchandise. The optical sensors can take continuous video or still images showing customers in the aisle where the shelf is located. Image data can be compared to preexisting image data from a database to determine customers traveling along or near the aisle in front of the merchandise, to determine customers physically touching an item of merchandise, and to then calculate a customer interest rate in the merchandise. The computing device 410 may use a counter to count customer movement at or near the shelf and to count actual handling of the merchandise by customers, and the ratio of these two values indicates a customer interest rate. Thus, the computing device 410 may be configured to analyze traffic patterns near merchandise based on calculation of a customer interest rate in the merchandise that compares the amount of movement of people with the amount of merchandise handling by people. This customer interest rate may be useful in evaluating the effectiveness of marketing and promotional efforts at or near the shelf, in determining customer interest in various areas of the shopping facility, and in determining whether the merchandise should be displayed at other locations of the shopping facility.

In another form, the computing device 410 may be configured to calculate a customer conversion/purchase rate. For example, the sensors 404 may be arranged to detect the handling of the merchandise at or near the shelf and the non-transitory removal of the merchandise from the shelf. In one form, the arrangement of sensors may include optical sensors (such as in a third array of sensors) that capture image data at or near the merchandise. Image data can be compared to preexisting image data from a database to identify customers physically touching the merchandise, to identify customers removing an item of merchandise from the shelf, and to then calculate a customer conversion rate in the merchandise. The optical sensors may be evaluated in conjunction with weight sensors (such as in a first array of sensors) that may indicate removal of merchandise based on a change in weight at some region of the shelf. The computing device 410 may use a counter to count physical touching of the merchandise and to count non-transitory removal of merchandise by customers, and the ratio of these two values indicates a customer conversion/purchase rate. Non-transitory removal can be determined by defined as removal from the shelf in excess of a certain amount of time. So, the computing device 410 may be configured to analyze traffic patterns near merchandise based on the calculation of a customer conversion rate in the merchandise that compares the amount of merchandise removal with the amount of merchandise handling. As with the customer interest rate, the customer conversion rate may be useful in evaluating the effectiveness of marketing and promotional efforts, in determining customer conversion/purchase rates in various areas of the shopping facility, and in determining whether to move the merchandise to a different location.

In a modified form, the sensors 404 may be arranged to detect handling of the merchandise by people, which may indicate tampering with the merchandise. For example, the computing device 410 may be configured to flag an incidence of merchandise handling if it satisfies certain conditions and to provide an alert to investigate the merchandise that has been handled. In one form, the computing device 410 may be configured to flag every instance of physical contact with an item of merchandise where the item is replaced on the shelf. This determination may be made based on a combination of data from optical sensors (such as in a third array) and weight sensors (such as in a first array). Alternatively, the computing device 410 may be configured to only flag instances where there is physical contact with an item of merchandise and the item is not replaced for a certain predetermined amount of time, i.e., the item was not replaced immediately. In another form, or in addition, the computing device 410 may be configured to flag instance where there is an addition in weight at a weight sensor (such as in a first array) at a time of day when re-stocking is not likely to occur (suggesting the possible addition of an unknown item to the shelf by an individual). As another alternative, or as an additional scenario, the computing device 410 may be configured to compare captured image data (such as from a third array) to preexisting image data from a database evincing known indicia of tampering. If any of these conditions are satisfied, in addition to providing an alert (such as to a sales associate or employee) to investigate the particular merchandise that has been handled, the computing device 410 may be configured to maintain a separate and/or collective running count of these instances possibly suggesting tampering. It is also contemplated that the evaluation of traffic patterns indicated above, including calculation of customer interest rate, customer conversion rate, and tampering, may be performed manually by an individual (instead of via computing device 410) or based on some combination of manual and computing activity.

Third, the computing device 410 may be configured to analyze stocking patterns 422 (and/or orientation of the merchandise by sales associates/employees). In the retail setting, one aspect of merchandise presentation is the orientation, or “facing,” of the merchandise, and it is generally desirable to have all of the merchandise items facing consistently in one direction, usually a forward direction. So, the sensors 404 may be arranged to detect the orientation of merchandise on the shelf at a shopping facility. In one form, the arrangement of sensors 404 may include optical sensors (such as in a third array of sensors) that capture image data of the merchandise. Image data can be compared to preexisting image data from a database to determine orientation. Alternatively, or in combination, weight sensors (such as in a first and/or second array) may indicate weight patterns suggesting that the merchandise items are not oriented in a similar manner and/or that one or more merchandise items may have fallen over. In some forms, the computing device 410 may be configured to capture image data at times where re-stocking of merchandise by sales associates frequently occurs.

So, the computing device 410 may be configured to analyze stocking patterns 422 of the merchandise over a predetermined amount of time to observe data trends relating to re-orientation of the merchandise on the shelf by employees at the shopping facility. The observation of data may include various ways of evaluating re-orientation, or facing, requirements, efforts by sale associates, and/or other trends, such as determining the accuracy of the re-orientation of the merchandise on the shelf by sales associates, determining the length of time after re-orienting by a sales associate that a predetermined number of merchandise items the merchandise becomes oriented incorrectly, counting the number of instances of re-orientation of the merchandise during a certain time interval, determining when re-orientation of the merchandise by a sales associate is performed, and determining the time intervals between instances of re-orientation of the merchandise. It is contemplated that the evaluation of stocking patterns and observation of data trends may be performed manually by an individual (instead of via computing device 410) or based on some combination of manual and computing activity.

Fourth, the computing device 410 may be configured to analyze the temperature history of merchandise 424. In one form, the sensors 404 may be arranged to measure the temperature of merchandise at or near the shelf at predetermined intervals, and in this form, the sensors include temperature sensors (such as in a second array). The periodic temperature readings may be stored in the sensory history database 414. The temperature readings may be used to establish cold chain compliance, i.e., to make sure the temperature of the merchandise (especially perishable merchandise) remains within a required temperature range, possibly at different locations of the shelf. For many types of merchandise, the temperature history of a product is the best predictor of the remaining shelf life. Continuous monitoring of temperature allows a determination of the amount of shelf life remaining and may lead to price adjustment (especially for merchandise such as produce).

Like with freshness levels addressed above, the computing device 410 may access data from the merchandise database 412 to be evaluated in conjunction with temperature readings to allow the calculation of a sell-by date, an estimated expiration date, and/or a stage of ripeness. In some forms, based on the temperature history, the computing device 410 may include a task to be performed by a sales associate, such as placing the merchandise on the sales floor, relocating the merchandise, removing the merchandise from sales, moving the merchandise into climate controlled storage, applying a discount to the merchandise, and the like. In some forms, the computing device 410 may generate a recommendation for the customers, such as: a best-by date, available discounts, a suggested use of the merchandise based on remaining shelf life, and the like. Measured temperature history data may be compared to preexisting temperature data from the merchandise database 412 for that particular merchandise that may be associated with preexisting remaining shelf life predictions for the merchandise. Thus, the computing device 410 may be configured to analyze the temperature history of the merchandise to determine shelf life. In addition, the computing device 410 may be configured to adjust the pricing of the merchandise based on the determination of shelf life.

It is also contemplated that the measured temperature readings in the sensory history database 414 may be used to modify the preexisting shelf life predictions in the merchandise database 412. For example, an evaluation of the temperature readings may show that merchandise with certain empirical temperature data exhibited either a shorter or longer shelf life for the merchandise than was predicted by preexisting standards. Accordingly, the sensory history database 414 can be iteratively evaluated to correct and update shelf life predictions for various types of merchandise. It is also contemplated that the evaluation of temperature history indicated above may be performed manually by an individual (instead of via computing device 410) or based on some combination of manual and computing activity.

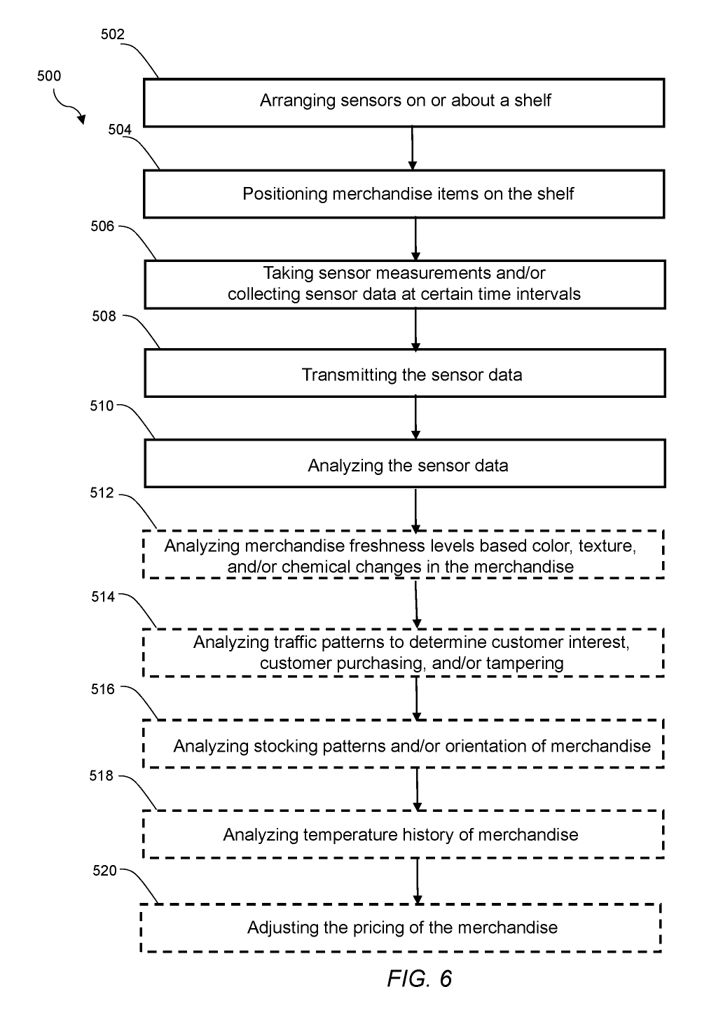

In FIG. 6, there is shown a flow diagram showing various steps of an illustrative process 500 that may make use of some of the components of system 400 described above. At block 502, a plurality of sensors are arranged about the shelf. In one form, the sensors may be arranged as a first, second, and (optionally) third array of sensors that may include various types of sensors, such as described above with respect to systems 100 and 200. At block 504, the merchandise items are deposited on the shelf, such as by a sales associate/employee stocking and orienting the merchandise on the shelf. At block 506, sensor measurements and/or data are taken/collected at certain time intervals, which may be different for the various types of sensors. At block 510, the sensor data may be analyzed with respect to one or more of the four following categories: (1) merchandise freshness levels based on color, texture, and/or chemical changes of the merchandise (block 512); (2) traffic patterns showing the customer interest rate, customer purchase/conversion rate, and/or suggestions of tampering with respect to the merchandise (block 514); (3) stocking patterns and/or orientation (or “facing”) of the merchandise (block 516); and (4) temperature history of the merchandise (block 518). At block 520, the pricing of the merchandise may be adjusted, such as based on a determination of the remaining shelf life of the merchandise.

So, in some embodiments, there is provided a system for monitoring sensor data of merchandise on shelves comprising: a shelf configured to support merchandise; an arrangement of sensors on or about the shelf; a control circuit operatively coupled to the arrangement of sensors and configured to take sensor data at predetermined time intervals; an interface operatively coupled to the control circuit, the interface configured to transmit the sensor data to a computing device; wherein the computing device is configured to analyze the sensor data over time to determine at least one of merchandise freshness levels, traffic patterns near the merchandise, stocking patterns of the merchandise, and merchandise temperature compliance.

Further implementations of these embodiments are provided. For example, in some implementations, the arrangement of sensors is configured to detect color or texture changes in the merchandise; and the computing device is configured to analyze merchandise freshness levels based on the analysis of the sensor data over a predetermined amount of time for color or texture changes of the merchandise to determine shelf life. In some implementations, the computing device is configured to adjust the pricing of the merchandise based on the determination of shelf life. In some embodiments, the arrangement of sensors is configured to detect gas emissions of chemicals from the merchandise indicating a change in freshness; and the computing device is configured to analyze merchandise freshness levels based on the analysis of the sensor data over a predetermined amount of time for chemical changes in the merchandise to determine shelf life. In some implementations, the arrangement of sensors is configured to detect movement of people at or near the shelf and handling of the merchandise by people; and the computing device is configured to analyze traffic patterns near merchandise based on calculation of a customer interest rate in the merchandise that compares the amount of movement of people with the amount of merchandise handling by people. In some implementations, the system further comprises at least one counter to count customer movement at or near the shelf and to count merchandise handling by customers. In some implementations, the arrangement of sensors is configured to detect handling of the merchandise at or near the shelf and non-transitory removal of the merchandise from the shelf; and the computing device is configured to analyze traffic patterns near merchandise based on calculation of a customer conversion rate in the merchandise that compares the amount of merchandise removal with the amount of merchandise handling. In some implementations, the system further comprises at least one counter to count customer handling of merchandise at or near the shelf and to count non-transitory customer removal of merchandise from the shelf. In some implementations, the arrangement of sensors is configured to detect handling of the merchandise by people indicating tampering with the merchandise; the computing device is configured to provide an alert to investigate the merchandise that has been handled; and the computing device is configured to count each instance of handling by the merchandise indicating tampering with the merchandise. In some implementations, the arrangement of sensors is configured to detect the orientation of merchandise on the shelf at a shopping facility; and the computing device is configured to analyze stocking patterns of the merchandise over a predetermined amount of time to observe data trends relating to re-orientation of the merchandise on the shelf by employees at the shopping facility. In some implementations, the observing data trends comprises at least one of determining the accuracy of the re-orientation of the merchandise on the shelf, determining the length of time after re-orienting that a predetermined number of merchandise items the merchandise becomes oriented incorrectly, counting the number of instances of re-orientation of the merchandise, determining when re-orientation of the merchandise occurs, and determining the time intervals between instances of re-orientation of the merchandise. In some implementations, the arrangement of sensors is configured to measure the temperature of merchandise at or near the shelf at predetermined time intervals; and the computing device is configured to analyze the temperature history of the merchandise to determine shelf life. In some implementations, the computing device is configured to adjust the pricing of the merchandise based on the determination of shelf life.

In some embodiments, there is provided a method for monitoring sensor data of merchandise on shelves comprising: positioning merchandise on a shelf; arranging a plurality of sensors on or about the shelf; by a control circuit, taking sensor data at predetermined time intervals; by an interface, transmitting the sensor data to a computing device; and analyzing the sensor data over time to determine at least one of merchandise freshness levels, traffic patterns near the merchandise, stocking patterns of the merchandise, and merchandise temperature compliance.

Further implementations of these embodiments are provided. For example, in some implementations, the method further comprises: by the plurality of sensors, detecting color, texture, or chemical changes in the merchandise; and analyzing merchandise freshness levels based on the analysis of the sensor data over a predetermined amount of time for color, texture, or chemical changes of the merchandise to determine shelf life. In some implementations, the method further comprises: by the plurality of sensors, detecting movement of people at or near the shelf and handling of the merchandise by people; and analyzing traffic patterns near merchandise based on calculation of a customer interest rate in the merchandise that compares the amount of movement of people with the amount of merchandise handling by people. In some implementations, the method further comprises: counting customer movement at or near the shelf and counting merchandise handling by customers. In some implementations, the method further comprises: by the plurality of sensors, detecting handling of the merchandise at or near the shelf and non-transitory removal of the merchandise from the shelf; and analyzing traffic patterns near merchandise based on calculation of a customer conversion rate in the merchandise that compares the amount of merchandise removal with the amount of merchandise handling. In some implementations, the method further comprises: counting customer handling of merchandise at or near the shelf and counting non-transitory customer removal of merchandise from the shelf. In some implementations, the method further comprises: by the plurality of sensors, detecting the orientation of merchandise on the shelf; and analyzing stocking patterns of the merchandise over a predetermined amount of time to observe data trends relating to re-orientation of the merchandise on the shelf by people. In some implementations, the observing data trends comprises at least one of determining the accuracy of the re-orientation of the merchandise on the shelf, determining the length of time after re-orienting that a predetermined number of merchandise items the merchandise becomes oriented incorrectly, counting the number of instances of re-orientation of the merchandise, determining when re-orientation of the merchandise occurs, and determining the time intervals between instances of re-orientation of the merchandise. In some implementations, the method further comprises: by the plurality of sensors, measuring the temperature of merchandise at or near the shelf at predetermined time intervals; and analyzing the temperature history of the merchandise to determine shelf life.

Those skilled in the art will recognize that a wide variety of other modifications, alterations, and combinations can be made with respect to the above described embodiments without departing from the scope of the invention, and that such modifications, alterations, and combinations are to be viewed as being within the ambit of the inventive concept.

What is claimed is:

1. A system for monitoring merchandise on shelves comprising:
a shelf comprising a bottom surface and at least one side surface and configured to support merchandise;
a first array of sensors arranged on the bottom surface of the shelf and configured to measure at least one of weight, pressure, temperature, and moisture;
a second array of sensors arranged on the at least one side surface of the shelf and configured to measure at least one of weight, pressure, temperature, and moisture; and
at least one interface operatively coupled to the first and second arrays of sensors, the at least one interface configured to transmit sensor data from the first and second arrays to a central computing system.

2. The system of claim 1, wherein the first array of sensors comprises a plurality of individual strips defining a grid extending along the bottom surface of the shelf

3. The system of claim 2, wherein the first array of sensors is formed of piezoelectric material and is configured to measure weight, pressure, temperature, and moisture at predetermined locations along the bottom surface of the shelf.

4. The system of claim 1, wherein the second array of sensors is disposed at predetermined vertical positions along the at least one side surface of the shelf.

5. The system of claim 4, wherein the second array of sensors comprises a plurality of individual strips defining a grid extending along the at least one side surface of the shelf.

6. The system of claim 1, wherein the first array or second array of sensors comprises at least one gas emission sensor.

7. The system of claim 1, wherein:
the at least one interface comprises an RFID device with a memory having a predetermined number of bits equaling the number of sensors in the first array of sensors; and
each bit corresponds to a sensor in the first array of sensors.

8. The system of claim 1, further comprising a third array of sensors disposed at predetermined vertical positions.

9. The system of claim 8, wherein the third array of sensors is disposed at a top surface of the shelf.

10. The system of claim 8 wherein the third array of sensors comprises one or more optical sensors.

11. The system of claim 10, wherein the one or more optical sensors comprise one or more charge-coupled devices (CCD) configured to identify the type or orientation of merchandise based on at least one of barcode labels, RFID tags, text recognition, or color recognition.

12. The system of claim 11, wherein the central computing system is configured to analyze the sensor data and determine shelf inventory, a liquid spill, a measured temperature exceeding a temperature threshold, or improper or misplaced merchandise on the shelf.

13. A method for monitoring merchandise on shelves comprising:
providing a shelf comprising a bottom surface and at least one side surface and configured to support merchandise;
by a first array of sensors, measuring at least one of weight, pressure, temperature, or moisture at predetermined locations along the bottom surface of the shelf;
by a second array of sensors, measuring at least one of weight, pressure, temperature, or moisture at predetermined locations along at least one side surface of the shelf; and
by at least one interface, transmitting sensor data from the first and second arrays to a central computing system.

14. The method of claim 13, wherein the first array of sensors is arranged as individual strips defining a grid extending along the bottom surface of the shelf.

15. The method of claim 13, wherein the second array of sensors is disposed at predetermined vertical positions along at least one side surface of the shelf.

16. The method of claim 13, further comprising, by a third array of sensors, identifying the type or orientation of merchandise based on at least one of barcode labels, RFID tags, text recognition, or color recognition.

17. The method of claim 16, wherein the third array of sensors comprises one or more optical sensors disposed at predetermined vertical positions.

18. The method of claim 16, further comprising transmitting sensor data from the first, second, and third sensors to a central computing system.

19. The method of claim 18, further comprising analyzing sensor data and determining shelf inventory, a liquid spill, a measured temperature exceeding a temperature threshold, or improper or misplaced merchandise on the shelf.
